(19) United States
(12) Patent Application Publication
(10) Pub. No.: US 2003/0076826 A1
(43) Pub. Date: Apr. 24, 2003

(54) Reliably transmitting a frame to multiple destinations by embedding sequence numbers in the frame

(75) Inventors: Richard John Blasiak, Chapel Hill, NC (US); David Wayne Cosby, Raleigh, NC (US); Anthony Matteo Gallo, Apex, NC (US); Sridhar Rao, Raleigh, NC (US); Sonia Kiang Rovner, Chapel Hill, NC (US); Frank Andrew Smoak, Cary, NC (US); Colin Beaton Verrilli, Apex, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machine Corporation, Armonk, NY

(21) Appl. No.: 10/002,476

(22) Filed: Oct. 23, 2001

(51) Int. Cl. H04L 12/28

(52) U.S. Cl. 370/389; 370/432

(57) ABSTRACT

A method, system and computer program product for reliably transmitting a frame. A transmitting node may be coupled to a plurality of destination nodes. The transmitting node may insert in a frame, e.g., multicast frame, to be transmitted to any two or more destination nodes coupled to the transmitting node two or more sequence numbers in the frame to be transmitted. The two or more sequence numbers may be associated with the two or more destination nodes. Upon transmitting the frame, the transmitting node may store a copy of the frame transmitted. Upon verifying that the frame has been delivered to each destination node to receive the frame, the memory associated with the transmitted frame may be released.

### TECHNICAL FIELD

The present invention relates to the field of data communication networks, and more particularly to reliably transmitting a frame of data in a multicast manner by embedding sequence numbers in the frame.

### BACKGROUND INFORMATION

Data communication networks have become commonplace in providing communications of digital data between a source, e.g., transmitting node, and a destination, e.g., destination node. Such systems include a plurality of switches and/or various transmission links used to interconnect source nodes and transmission nodes.

Data communication networks may be capable of transmitting frames of data in a unicast or multicast manner. Unicast may refer to transmitting a frame of data to a single destination node. Multicast may refer to transmitting a frame of data to a group of recipients, commonly referred to as a multicast group, via a single transmission.

Message transmission from senders, i.e., transmitting nodes, to recipients, i.e., destination nodes, may be unreliable, i.e., messages that are sent may not be guaranteed to be received properly or in order. Because message transmission in a network may be unreliable, methods have been developed to determine the success of the delivery of a message such as a multicast frame of data.

One method for determining the success of the delivery of a multicast frame of data to a multicast group is to embed a single sequence number in the frame. A sequence number may refer to the particular order of the frame transmitted by the transmitting node to a particular multicast group with respect to the transmission of other frames to that particular multicast group. Each destination node in the multicast group may be configured to track the expected sequence number associated with the multicast frame expected to be received. If the destination node in the multicast group receives a multicast frame with the expected sequence number, the destination node may be configured to process the received frame and transmit an acknowledgment to the transmitting node. A copy of the multicast frame may be maintained in memory by the transmitting node so that it may be retransmitted to particular members in the multicast group that fail to transmit an acknowledgement. Upon receipt of an acknowledgment from a member, i.e., a destination node, in the multicast group, the transmitting node may record the acknowledgment in an internal data structure associated with the frame and destination node. Upon receipt of acknowledgements from each and every destination node in the multicast group, the transmitting node may release, i.e., free-up, memory associated with the copy of the multicast frame maintained for possible retransmission.

However, in order to determine the success of the delivery of a multicast frame to a subset of members of a multicast group, i.e., particular destination nodes in a multicast group, the multicast frame of data must be transmitted to each member. That is, the transmitting node may not determine the success of the delivery of a multicast frame when the transmitting node transmits a multicast frame to a subset of the multicast group, e.g., two of the three members in a multicast group. The transmitting node may only determine the success of the delivery of a multicast frame when the transmitting node transmits a multicast frame to each member of the multicast group. Since every member of the multicast group must receive and process the sequence number for each frame even if the contents, i.e., payload, of the received frames are not needed, the bandwidth of the destination nodes may be unnecessarily used. In the case of a data communication network, bandwidth may be unnecessarily used between the switch and the nodes that do not need to process the frame contents. Furthermore, since every member of the multicast group must send acknowledgements to the transmitting node, those members that do not need to receive and process the frame contents may transmit unnecessary acknowledgments to the transmitting node. By transmitting unnecessary acknowledgments, the processing power of those destination nodes and of the transmitting node may be unnecessarily used. Furthermore, by transmitting unnecessary acknowledgments the bandwidth of the network may be unnecessarily used. Furthermore, if a frame that is transmitted to a destination node such as a destination node that does not need to process the frame contents is lost, or if this destination node is temporarily unable to process the frame sequence number, or if the acknowledgement that this destination node transmits back to the transmitting node is lost, the transmitting node will retransmit the frame to that destination node thereby unnecessarily using resources in the transmitting node, destination node and in the data communication network.

It would therefore be desirable to be able to determine the success of the delivery of a multicast frame to a subset of members of a multicast group without transmitting the multicast frame to each member of the multicast group. By being able to determine the success of the delivery of a multicast frame to a subset of members of a multicast group without transmitting the multicast frame to each member of the multicast group, fewer resources are used in the transmitting node, in the data communication network and in those destination nodes that no longer need to receive the frame or send an acknowledgment.

### SUMMARY

The problems outlined above may at least in part be solved in some embodiments by inserting two or more sequence numbers in the frame, e.g., multicast frame, to be transmitted where each sequence number is associated with a particular destination node to receive the transmitted frame.

In one embodiment of the present invention, a method for reliably transmitting a frame, e.g., multicast frame, may comprise the step of a transmitting node inserting appropriate bits in a frame header of the frame to select appropriate ports of a switch fabric from which to transmit the frame to the appropriate destination nodes. The switch fabric may be coupled to the transmitting node and a plurality of destination nodes. The transmitting node may further set a bit in the frame header of the frame to indicate whether an explicit or implicit acknowledgment is required from the destination node that receives the frame. An explicit acknowledgment may refer to requiring the destination node that received the frame to transmit a response to the transmitting node to transmit the next frame to be transmitted to that destination node with the next higher sequence number. For example, if the transmitting node transmitted a frame with a sequence number of the binary number 00000001 and the frame had a bit set to indicate an explicit acknowledgment is required from the destination node, then the destination node may transmit a response requesting that the next frame to be transmitted to that destination node have a sequence number of the binary number 00000010. An implicit acknowledgment may refer to not requiring the destination node that received the frame to transmit a response acknowledging the delivery of the frame.

The transmitting node may insert two or more sequence numbers in appropriate entries in an identifier field in the frame to be transmitted. The identifier field may be part of the frame header. The identifier field may comprise a plurality of entries where each entry may be associated with a particular destination node coupled to the transmitting node via the switch fabric. Each entry in the identifier may store a particular sequence number that is used by the associated destination node. A sequence number may refer to the particular order of the frame transmitted by the transmitting node to a particular destination node with respect to the transmission of other frames to that destination node. The transmitting node may then insert two or more sequence numbers in the appropriate entries in the identifier field to identify the destination nodes to receive the transmitted frame.

Upon transmitting the frame, the transmitting node may store a copy of the transmitted frame. The transmitting node may then determine if the transmitting node has received a request to retransmit a frame from one of the plurality of destination nodes coupled to the transmitting node. A destination node may be configured to transmit a request to the transmitting node to retransmit a frame with its expected sequence number upon that destination node receiving a frame with a sequence number greater than the expected sequence number. If the transmitting node receives such a request, then the transmitting node may retransmit the requested frame. Upon retransmitting the frame, the transmitting node may wait to receive an acknowledgment from one of the plurality of destination nodes. If the transmitting node has not received a request to retransmit a frame, e.g., multicast frame, from one of the plurality of destination nodes, then the transmitting node may determine if it has received an acknowledgment from one of the plurality of destination nodes. If the transmitting node has not received an acknowledgment from one of the plurality of destination nodes, then the transmitting node may wait to receive an acknowledgment from one of the plurality of destination nodes.

If the transmitting node has received an acknowledgment from one of the plurality of destination nodes then the transmitting node may identify the appropriate destination node and the sequence number associated with the received frame. The transmitting node may then read data structures associated with the frames transmitted by the transmitting node. Each frame transmitted may be associated with a data structure storing information as to which destination node was to receive the frame as well as the associated sequence number. The sequence number may indicate the sequence that the frame was sent to the associated destination node with respect to other frames transmitted to that destination node.

Upon reading the data structures associated with the frames transmitted, the transmitting node may identify the frame associated with the acknowledgment received. Upon identifying the frame associated with the received acknowledgment, the transmitting node may indicate that the transmitting node received the acknowledgment from the appropriate destination node in the data structure associated with the identified frame.

The transmitting node may further read the data structure of the destination node associated with the frame identified. The transmitting node may store a data structure for each of the destination nodes that are to receive a frame transmitted by the transmitting node. The data structure may comprise one or more entries where each entry may comprise a frame identification and a sequence number where the sequence number is the sequence that the frame was transmitted to the destination node of the data structure with respect to other frames transmitted to that destination node. The data structure may further comprise information as to whether the frame identified by the frame identification was transmitted with a request to transmit an acknowledgment or not. The transmitting node may then indicate that the frame was delivered to the destination node in the data structure.

The transmitting node may then determine if there are any entries in the data structure of the destination node with any implicit acknowledgments that need to be identified. For example, since a destination node may transmit an acknowledgment upon receiving a frame with an expected acknowledgment, the transmitting node may identify any previous frames with an implicit acknowledgment as having been received by the destination node. If the transmitting node identifies any entries with an implicit acknowledgment that needs to be identified, then the transmitting node may identify these entries. Upon identifying any entries associated with the implicit acknowledgment, the transmitting node may identify these entries in the data structure(s) associated with the frame(s) with the implicit acknowledgment.

If the transmitting node does not identify any entries in the data structure of the destination node with any implicit acknowledgments that need to be identified then the transmitting node may determine if there is a missing sequence number. As stated above, the transmitting node may indicate that the transmitting node received an acknowledgment that the frame was delivered for the appropriate frame in the data structure for the appropriate destination node. If the transmitting node identifies a frame associated with the received acknowledgment with a sequence number that is greater than expected, then the transmitting node may detect a lost acknowledgment. For example, if the transmitting node transmitted frame #1 followed by frame #2 to destination node #1, where both frame #1 and #2 were transmitted with a request to transmit an acknowledgment, and received an acknowledgment from destination node #1 that it received frame #2 without receiving an acknowledgment from destination node #1 that it received frame #1, then the transmitting node may have detected that the acknowledgment that the destination node received frame #1 was lost.

If the transmitting node does not identify a missing sequence number, then the transmitting node may determine if there are any outstanding responses for the frame received. As stated above, each frame may be associated with a data structure. As an acknowledgment from each destination node for a particular frame is received, the transmitting node may indicate in the appropriate entry in the appropriate data structure associated with the delivered frame that the frame was delivered. That is, the transmitting node may indicate each destination node that issued an acknowledgment. The transmitting node may then determine if there are any more destination nodes that have not issued an acknowledgment of having received the particular frame in question. If there are outstanding responses, i.e., any outstanding acknowledgments from any destination nodes, then the transmitting node may wait to receive a further acknowledgment from another destination node. If the transmitting node has identified all the destination nodes that were transmitted the frame identified as having transmitted an acknowledgment, then the transmitting node may release memory associated with a single copy of the frame identified. By transmitting a frame, e.g., multicast frame, with sequence numbers associated with destination nodes, the transmitting node may be able to store a single copy of the transmitted frame instead of multiple copies of the transmitted frame. Subsequently, fewer resources may be used for storing copies of transmitted frames.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a network system configured in accordance with the present invention;

FIG. 2 illustrates an embodiment of the present invention of nodes in a network system;

FIG. 3 is a flowchart of a method for reliably transmitting a frame in accordance with the present invention;

FIG. 4 illustrates an embodiment of the present invention of a frame;

FIG. 5 illustrates an embodiment of the present invention of an identifier field in a frame;

FIG. 6 is a flowchart of a method for responding by a destination node to a received frame;

FIG. 7 illustrates a data structure associated with each frame maintained by the transmitting node in accordance with the present invention; and

FIG. 8 illustrates a data structure associated with each destination node maintained by the transmitting node in accordance with the present invention.

### DETAILED DESCRIPTION

The present invention comprises a method, system and computer program product for reliably transmitting a frame. In one embodiment of the present invention, a transmitting node may be coupled to a plurality of destination nodes. The transmitting node may insert in a frame, e.g., multicast frame, to be transmitted to any two or more destination nodes coupled to the transmitting node two or more sequence numbers in the frame to be transmitted. The two or more sequence numbers may be associated with the two or more destination nodes. Upon transmitting the frame, the transmitting node may store a copy of the frame transmitted. Upon verifying that the frame has been delivered to each destination node to receive the frame, the memory associated with the transmitted frame may be released. It is noted that even though the following discusses inserting sequence numbers in a frame, e.g., multicast frame, to identify the destination nodes to receive the frame that the present invention may include an embodiment of inserting sequence numbers in a particular frame in a Protocol Data Unit (PDU) comprised of a series of frames. That is, the sequence numbers may only need to appear once in the PDU and not in every frame of the PDU.

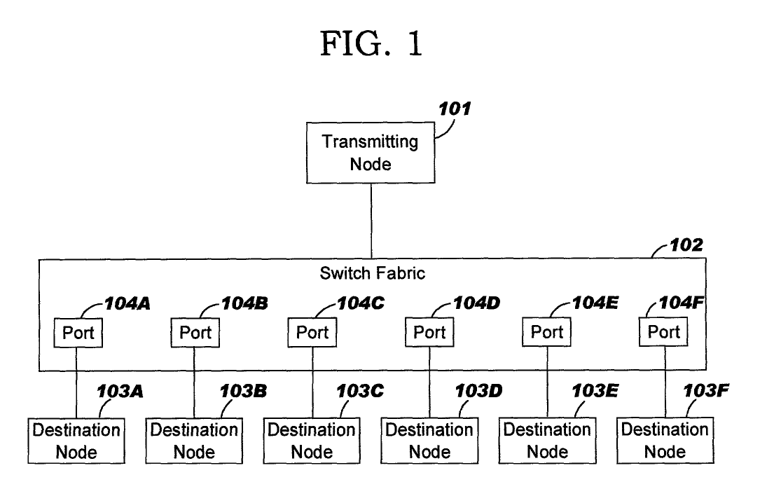

FIG. 1—Network System

FIG. 1 illustrates an embodiment of the present invention of a network system 100. Network system 100 may comprise a transmitting node 101 coupled to a plurality of destination nodes 103A-F via a switch fabric 102, e.g., Internet switch. Destination nodes 103A-F may collectively or individually be referred to as destination nodes 103 or destination node 103, respectively. Transmitting node 101 may be configured to transmit one or more frames of data, e.g., multicast frames of data, to two or more destination nodes 102 via switch fabric 102. Switch fabric 102 may comprise a plurality of ports 104A-F coupled to a plurality of destination nodes 103A-F. Ports 104A-F may collectively or individually be referred to as ports 104 or port 104, respectively. Each port 104 may be associated with a particular destination node 103 as illustrated in FIG. 1. Switch fabric 102 may be configured to direct a particular frame, e.g., multicast frame, received from transmitting node 101 to the appropriate two or more destination nodes 103 by directing the particular frame through the appropriate ports 104 coupled to the appropriate destination nodes 103. It is noted that system 100 may comprise any number of destination nodes 103 coupled to switch fabric 102. It is further noted that switch fabric 102 may comprise any number of ports 104. It is further noted that system 100 may comprise any number of transmitting nodes 101 and associated switch fabrics 102 and that FIG. 1 is not to be limited in scope to any one particular embodiment.

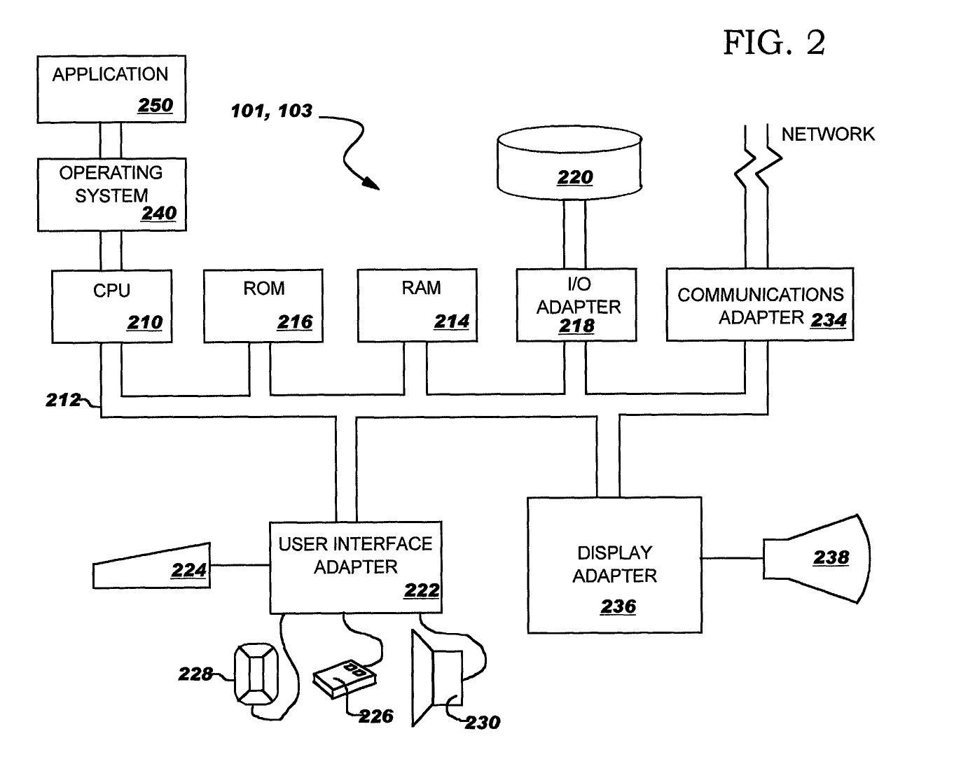

FIG. 2—Hardware Configuration of Nodes

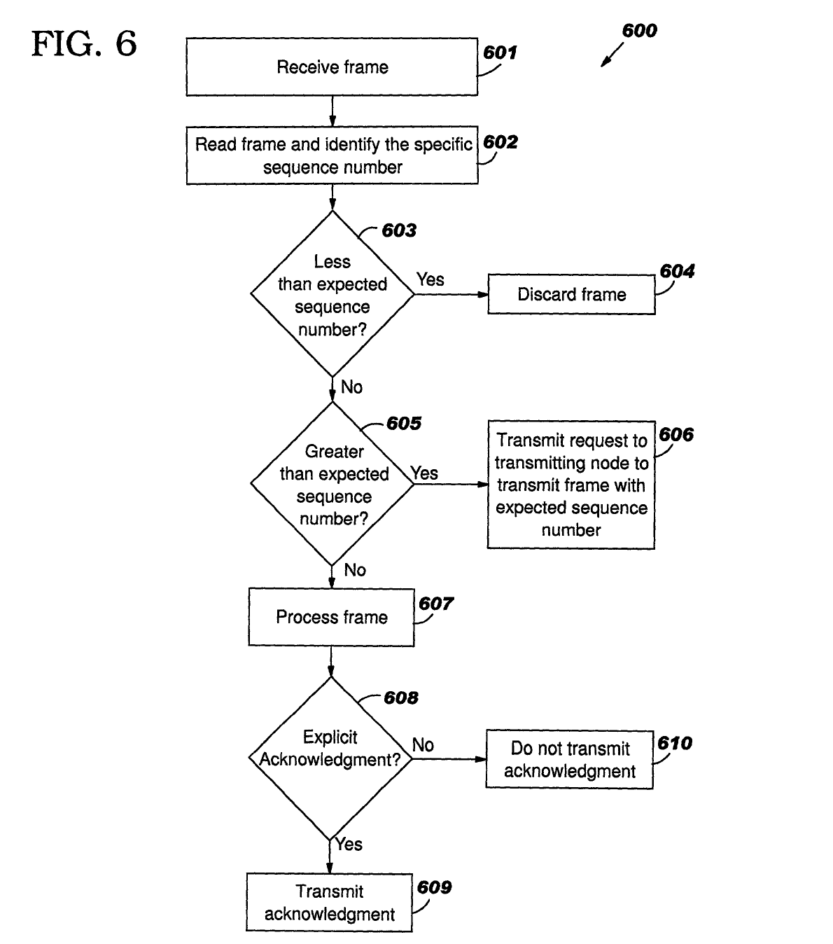

FIG. 2 illustrates an embodiment of the present invention of nodes 101, 103. It is noted that the description provided below describes an exemplary embodiment of nodes 101, 103 and that the embodiments of nodes 101, 103 are not to be limited in scope to any one particular embodiment. For example, node 103 may not comprise an operating system as illustrated in FIG. 2 and subsequently the program of the present invention that responds to a received frame as described in the discussion of FIG. 6 may be implemented as a communications device driver.

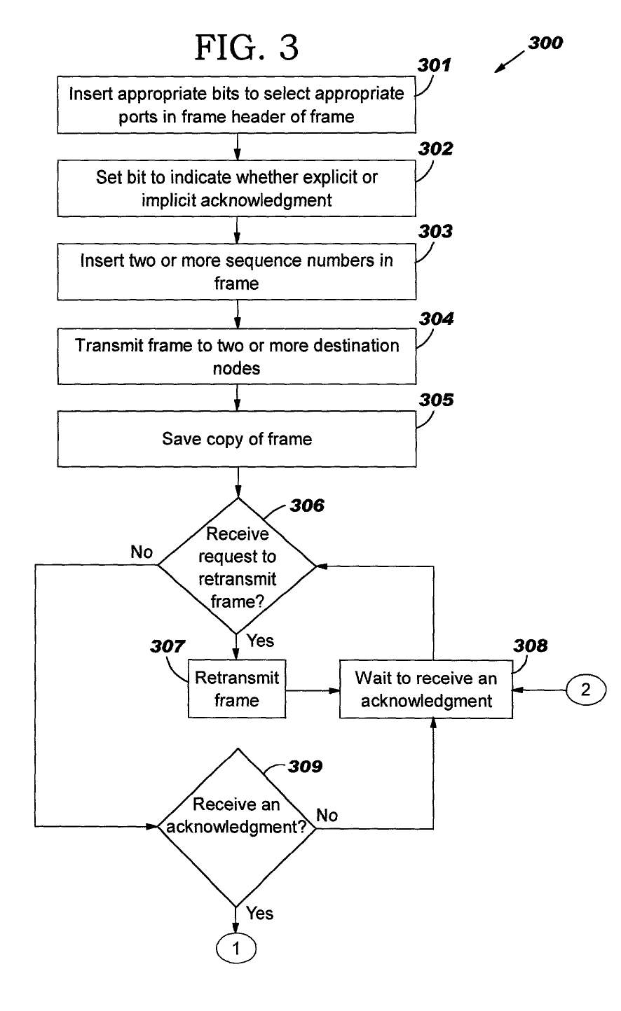

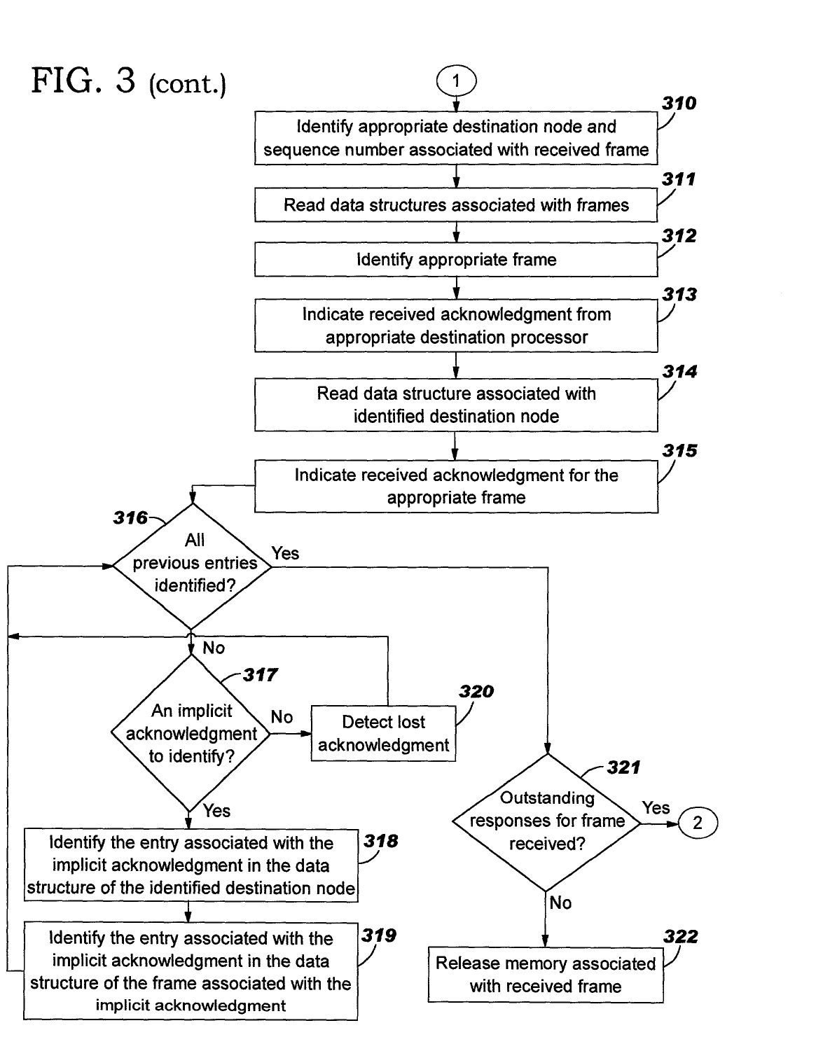

Referring to FIG. 2, nodes 101, 103 may comprise a central processing unit (CPU) 210 coupled to various other components by system bus 212. An operating system 240, e.g., AIX, UNIX, may run on CPU 210 and provide control and coordinate the function of the various components of FIG. 2. An application 250 in accordance with the principles of the present invention may run in conjunction with operating system 240 and provide output calls to operating system 240 where the output calls implement the various functions or services to be performed by application 250. In one embodiment, application 250 of node 101 may include for example, a program for reliably transmitting frames of data as described in the discussion of FIG. 3. In one embodiment, application 250 of node 103 may include for example, a program for responding to a received frame as described in the discussion of FIG. 6.

Referring to FIG. 2, read only memory (ROM) 216 may be coupled to system bus 212 and include a basic input/output system (“BIOS”) that controls certain basic functions of node 101, 103. Random access memory (RAM) 214, I/O adapter 218, and communications adapter 234 may also be coupled to system bus 212. It should be noted that software components including operating system 240 and application 250 may be loaded into RAM 214 which is the computer system's main memory. I/O adapter 218 may be a small computer system interface (“SCSI”) adapter that communicates with disk unit 220, e.g., disk drive. It is noted that the program of the present invention that reliably transmits frames of data, as described in the discussion for FIG. 3, may reside in disk unit 220 or application 250 of node 101. It is further noted that the program of the present invention that responds to a received frame, as described in the discussion for FIG. 6, may reside in disk unit 220 or application 250 of node 103.

Referring to FIG. 2, communications adapter 234 may interconnect bus 212 with an outside network enabling transmitting node 101 to transmit frames via switch fabric 102 to destination nodes 103. Furthermore, communications adapter 234 may interconnect bus 212 with an outside network enabling destination node 103 to receive frames of data via switch fabric 102 from transmitting node 101.

Referring to FIG. 2, keyboard 224, mouse 226 and speaker 230 may all be interconnected to bus 212 through user interface adapter 222. Event data may be inputted to node 101, 103 through any of these devices. Display monitor 238 may be connected to system bus 212 by display adapter 236. In this manner, a user may be capable of inputting to node 101, 103 through keyboard 224 or mouse 226 and receiving output from node 101, 103 via display 238 or speaker 230.

Implementations of the invention include implementations as a computer system programmed to execute the method or methods described herein, and as a computer program product. According to the computer system implementations, sets of instructions for executing the method or methods are resident in the random access memory 214 of one or more computer systems configured generally as described above. Until required by node 101, 103, the set of instructions may be stored as a computer program product in another computer memory, for example, in disk drive 220 (which may include a removable memory such as an optical disk or floppy disk for eventual use in disk drive 220). Furthermore, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 3—Method for Reliably Transmitting a Frame of Data

FIG. 3 illustrates a flowchart of one embodiment of the present invention of a method 300 for reliably transmitting a frame, e.g., multicast frame, to two or more destination nodes 103 by transmitting node 101 via switch fabric 102. As stated in the Background Information section, one method for determining the success of the delivery of a multicast frame to a multicast group is to embed a single sequence number in the frame. A sequence number may refer to the particular order of the frame transmitted by the transmitting node to a particular multicast group with respect to the transmission of other frames to that particular multicast group. However, in order to determine the success of the delivery of a multicast frame to a subset of members of a multicast group, i.e., particular destination nodes in a multicast group, the multicast frame must be transmitted to each member. That is, the transmitting node may not determine the success of the delivery of a multicast frame when the transmitting node transmits a multicast frame to a subset of the multicast group, e.g., two of the three members in a multicast group. The transmitting node may only determine the success of the delivery of a multicast frame when the transmitting node transmits a multicast frame to each member of the multicast group. It would therefore be desirable to be able to determine the success of the delivery of a multicast frame to a subset of members of a multicast group without transmitting the multicast frame to each member of the multicast group. By being able to determine the success of the delivery of a multicast frame to a subset of members of a multicast group without transmitting the multicast frame to each member of the multicast group, fewer resources are used in the transmitting node, in the data communication network and in those destination nodes that no longer need to receive the frame or send an acknowledgment. Method 300 is a method for determining the success of the delivery of a multicast frame to a subset of a multicast group, e.g., two of the three destination nodes of the multicast group, without transmitting the multicast frame to each member of the multicast group.

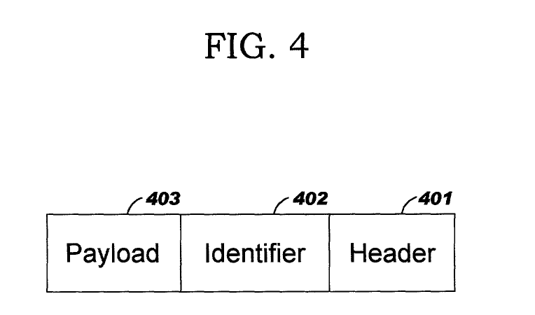

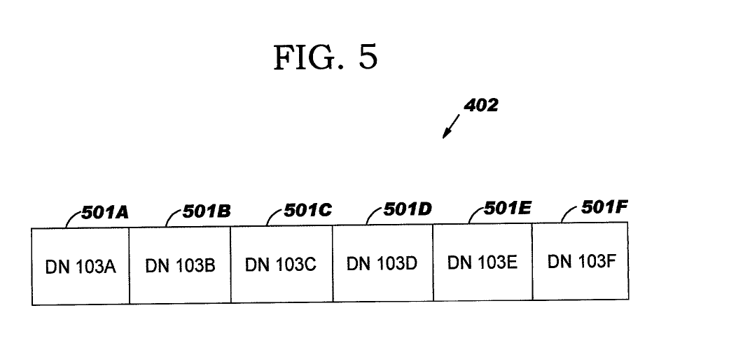

In step 301, transmitting node 101 may insert appropriate bits in a frame header of a frame, as illustrated in FIG. 4, to select appropriate ports 104 of switch fabric 102 from which to transmit the frame to the appropriate destination nodes 103. Referring to FIG. 4, FIG. 4 illustrates an embodiment of the present invention of a frame 400, e.g., multicast frame, where frame 400 may comprise a header field 401, an identifier field 402 and a payload 403. Header field 401 may comprise information, e.g., bits of information, as to which ports 104 in switch fabric 102 may be used to transmit the frame to the appropriate two or more destination nodes 103. Header field 401 may further comprise information, e.g., a bit of information, as to whether the frame requires an explicit or implicit acknowledgment from the received destination nodes 103 as explained in greater detail below. Identifier field 402 may comprise a plurality of entries where each entry may store a sequence number associated with a particular destination node 103 coupled to transmitting node 101. For example, referring to FIG. 1, since there are six destination nodes 103 coupled to transmitting node 101 via switch fabric 102, there may be six entries to insert six sequence numbers in identifier field 402 as illustrated in FIG. 5.

FIG. 5 illustrates an embodiment of the present invention of identifier field 402. Referring to FIG. 5, identifier field 402 may comprise a plurality of entries 501A-F which may be associated with destination nodes 103A-F. Entries may collectively or individually be referred to as entries 501 or entry 501, respectively. It is noted that identifier field 402 may comprise any number of entries 501 and that FIG. 5 is illustrative. Each entry 501 may store a sequence number associated with a particular destination node 103 associated with that entry 501. A sequence number may refer to the particular order of the frame transmitted by transmitting node 101 to a particular destination node 103 with respect to the transmission of other frames to that particular destination node 103. For example, the entry 501A in identifier field 401 may contain the sequence number associated with destination node 103A. Entry 501B may contain the sequence number associated with destination node 103B. Entry 501C may contain the sequence number associated with destination node 103C. Entry 501D may contain the sequence number associated with destination node 103D. Entry 501E may contain the sequence number associated with destination node 103E. Entry 501F may contain the sequence number associated with destination node 103F. In one embodiment, each sequence number used to identify a particular destination node 103 may be embodied in a 16-bit word. That is, each entry 501 may have a length of 16 bits.

Referring to FIG. 4, payload 403 of frame 400 may comprise data, e.g., video, audio, images. It is noted that identifier field 402 may be part of header field 401. It is further noted that frame 400 may comprise any number of fields containing any type of information and that FIG. 4 is illustrative.

Referring to FIG. 3, in step 302, a bit may be set to indicate whether an explicit or implicit acknowledgment is required from the destination node 103 that receives the frame. An explicit acknowledgment may refer to requiring destination node 103 that received that frame to transmit a response to transmitting node 101 to transmit the next frame to be transmitted to that destination node 103 with the next higher sequence number. For example, if transmitting node 101 transmits frame #1 with a sequence number of the binary number 00000001, where frame #1 has a bit set to indicate an explicit acknowledgment, then destination node 103 may be configured to transmit a response requesting transmitting node 101 to transmit the next frame to be transmitted to that destination node 103 with the next higher sequence number, e.g., binary number 00000010. An implicit acknowledgment may refer to not requiring destination node 103 that received that frame to transmit a response acknowledging the delivery of the frame. The delivery of frames marked with an implicit acknowledgment may be verified upon transmitting node 101 receiving an explicit acknowledgment from a subsequent delivered frame as described in additional detail below.

In step 303, transmitting node 101 may insert two or more sequence numbers in the appropriate entries 501 in identifier field 402 of frame 400 to identify the destination nodes 103 to receive the transmitted frame. As stated above, each sequence number may be used to identify a particular destination node 103 to receive a frame, e.g., multicast frame, from transmitting node 101. For example, referring to FIG. 1, if transmitting node 101 intends to transfer a particular frame, e.g., multicast frame, to destination nodes 103A, 103C, then transmitting node 101 may insert the appropriate sequence number in entries 501A, 501C. The other entries 501 in identifier field 402 may be empty, e.g., comprise zero's.

In step 304, transmitting node 101 may transmit the frame, e.g., multicast frame, to two or more destination nodes 103 through the appropriate ports 104 of switch fabric 102 as indicated in step 301. A description of possible responses by each destination node 103 that received a transmitted frame is described further below in conjunction with the discussion of FIG. 6.

In step 305, a copy of the transmitted frame may be saved in memory, e.g., RAM 214, or in a storage medium, e.g., disk unit 220, by transmitting node 101.

Referring to FIG. 6, FIG. 6 illustrates a flowchart of one embodiment of the present invention of a method 600 for responding by a destination node 103 upon receiving a frame, e.g., multicast frame.

In step 601, a particular destination node 103, e.g., destination node 103A, may receive a frame, e.g., multicast frame, transmitted by transmitting node 101 in step 304.

Upon receipt of the frame, destination node 103, e.g., destination node 103A, may read the received frame, e.g., read header field 401 and identifier field 402, in step 602. Destination node 103, e.g., destination node 103A, may read the sequence number, e.g., binary number 00000110, associated with it in the appropriate entry 501, e.g., entry 501A, in identifier field 402 of frame 400 in step 602. For example, destination node 103A may be configured to read entry 501A in identifier field 402 associated with destination node 103A. Entry 501A may contain the sequence number, e.g., binary number 00000110, associated with the transmitted frame for destination node 103A.

In step 603, destination node 103, e.g., destination node 103A, may determine if the sequence number read in step 602 is less than the expected sequence number. Each destination node 103 may be configured to track the expected sequence number associated with the frame, e.g., multicast frame, expected to be received. If the sequence number read in step 602 is less than the expected sequence number, then destination node 103, e.g., destination node 103A, may discard the received frame in step 604. Destination node 103 may be configured to discard the received frame in step 604 since the frame may have been a retransmission.

If the sequence number read in step 602 is not less than the expected sequence number, then destination node 103, e.g., destination node 103A, may determine if the sequence number read in step 602 is greater than the expected sequence number in step 605. If the sequence number read in step 602 is greater than the expected sequence number, then destination node 103 may transmit a request to transmitting node 101 to transmit the frame, e.g., multicast frame, associated with the expected sequence number in step 606.

If the sequence number read in step 602 is not greater than the expected sequence number, then the sequence number matches the expected sequence number and the frame is processed by destination node 103, e.g., destination node 103A, in step 607.

In step 608, a determination may be made by destination node 103, e.g., destination node 103A, as to whether an explicit acknowledgment is required by transmitting node 101. As stated above, destination node 103 may be configured to read the frame, e.g., header field 401, identifier field 402, in step 602. Header field 401 may comprise information, e.g., a bit of information, as to whether transmitting node 101 requires an explicit or implicit acknowledgment from the received destination nodes 103. Upon reading header field 401, destination node 103, e.g., destination node 103A, may be configured to determine if an explicit acknowledgment is required by transmitting node 101.

If an explicit acknowledgment is required by transmitting node 101, then destination node 103, e.g., destination node 103A, may transmit an acknowledgment in step 609. In one embodiment, the acknowledgment may comprise a request to transmit the next frame to be transmitted to that destination node 103, e.g., destination node 103A, with the next higher sequence number, e.g., binary number 00000111.

If an explicit acknowledgment is not required by transmitting node 101, then destination node 103, e.g., destination node 103A, may not transmit an acknowledgment in step 610.

Returning to FIG. 3, transmitting node 101 may determine if transmitting node 101 has received a request to retransmit a frame, e.g., multicast frame, from one of the plurality of destination nodes 103 coupled to transmitting node 101 in step 306. As stated above, destination node 103, e.g., destination node 103A, may be configured to transmit a request to transmitting node 101 to retransmit a frame with its expected sequence number upon that destination node 103 receiving a frame with a sequence number greater than the expected sequence number. If transmitting node 101 has received a request to retransmit a frame, e.g., multicast frame, from one of the plurality of destination nodes 103, then transmitting node 101 may retransmit the frame, e.g., multicast frame, associated with the received sequence number in step 307. A description of identifying the frame associated with the received sequence number is described further below. Upon retransmitting the frame, transmitting node 101 may wait to receive an acknowledgment from one of the plurality of destination nodes 103 in step 308.

If transmitting node 101 has not received a request to retransmit a frame, e.g., multicast frame, from one of the plurality of destination nodes 103, then transmitting node 101 may determine if it has received an acknowledgment from one of the plurality of destination nodes 103 in step 309. If transmitting node 101 has not received an acknowledgment from one of the plurality of destination nodes 103, then transmitting node 101 may wait to receive an acknowledgment from one of the plurality of destination nodes 103 in step 308

If transmitting node 101 has received an acknowledgment from one of the plurality of destination nodes 103, then transmitting node may identify the appropriate destination node 103, e.g., destination node 103A, and the sequence number associated with the received frame in step 310. As stated above, upon destination node 103 receiving a frame with a sequence number that matches an expected sequence number, destination node 103 may be configured to transmit an acknowledgment to transmitting node 101. The acknowledgment may comprise a request to transmit the next frame to be transmitted to that destination node 103 with the next higher sequence number. Transmitting node 101 may be configured to identify the destination node 103, e.g., destination node 103A, that transmitted the acknowledgment as well as the sequence number associated with the received frame. The sequence number associated with the received frame is the next lower sequence number from the sequence number in the acknowledgment.

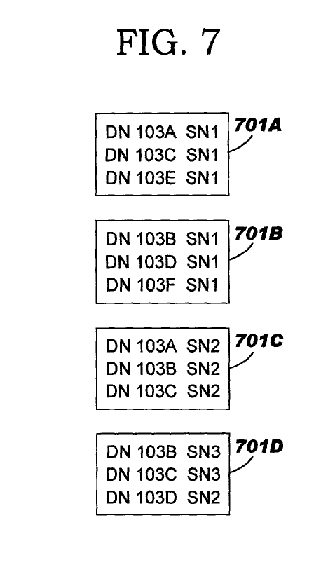

In step 311, transmitting node 101 may read data structures associated with frames, e.g., multicast frames, transmitted by transmitting node 101. In one embodiment, each frame transmitted may be associated with a data structure, as illustrated in FIG. 7, configured to identify which destination nodes 103 received that particular frame. Furthermore, the data structure of the frame may comprise the sequence numbers associated with each destination node 103 to receive the frame. In one embodiment, the data structures may be stored in memory, e.g., RAM 214, or in a storage medium, e.g., disk unit 220.

Referring to FIG. 7, FIG. 7 illustrates an embodiment of the present invention of data structures 701A-D. Data structures 701A-D may collectively or individually be referred to as data structures 701 or data structure 701, respectively. It is noted that data structure 701 may comprise any number of entries storing any type of information and that FIG. 7 is illustrative. It is fturther noted that transmitting node 101 may transmit any number of frames and hence may store any number of data structures 701. As stated above, each data structure 701 may be associated with a particular frame transmitted by transmitting node 101. For example, frame #1 may be associated with data structure 701A. Frame #2 may be associated with data structure 701B. Frame #3 may be associated with data structure 701C. Frame #4 may be associated with data structure 701D. As stated above, each data structure 701 may comprise information as to which destination nodes 103 were to receive the frame associated with data structure 701 as well as the sequence numbers associated with each destination node 103 to receive the frame. For example, destination nodes 103A, 103C and 103E are to receive frame #1. Each destination node 103, e.g., destination nodes 103A, 103C, 103E, has a sequence number of 1 associated with frame #1. Destination nodes 103B, 103D and 103F are to receive frame #2. Each destination node 103, e.g., destination nodes 103B, 103D, 103F, has a sequence number of 1 associated with frame #2. Destination nodes 103A, 103B and 103C are to receive frame #3. Each destination node 103, e.g., destination nodes 103A, 103B, 103C, has a sequence number of 2 associated with frame #3. Destination nodes 103B, 103C and 103D are to receive frame #4. Destination nodes 103B and 103C have a sequence number of 3 associated with frame #4; whereas, destination nodes 103D has a sequence number of 2 associated with frame #4.

Upon reading the data structures associated with frames, e.g., multicast frames, transmitted by transmitting node 101, transmitting node 101 may identify the frame associated with the acknowledgment received in step 312. For example, if transmitting node 101 receives an acknowledgment that requests sequence number 4 from destination node 103B, then transmitting node 101 may identify the frame, e.g., frame #4, transmitted to destination node 103B with sequence number 3 as being delivered to destination node 103B. Upon identifying the appropriate destination node 103, e.g., destination node 103B, and the sequence number associated with the delivered frame, transmitting node may read the data structures for a matching destination node 103 and sequence number pair. Referring to FIG. 7, frame #4 comprises an entry listing destination node 103B and sequence number 3. Subsequently, in step 312, transmitting node 101 may identify frame #4 as being associated with the acknowledgment received.

Upon identifying the frame associated with acknowledgment received in step 312, transmitting node 101 may indicate the received acknowledgment from the appropriate destination node 103, e.g., destination node 103B, in data structure 701 associated with the transmitted frame in step 313. For example, transmitting node 101 may indicate in the first entry in data structure 701D that the frame associated with data structure 701D has been delivered by marking that entry.

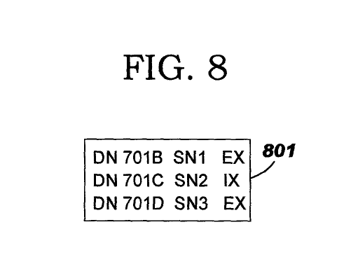

In step 314, transmitting node 101 may read the data structure of destination node 103, e.g., destination node 103B, associated with the frame identified in step 312. FIG. 8 illustrates an embodiment of a data structure 801 for a destination node 103, e.g., destination node 103B. It is noted that data structure 801 may comprise any number of entries storing any type of information and that FIG. 8 is illustrative. In one embodiment, transmitting node 101 may be configured to store data structure 801 associated with each destination node 103 in memory, e.g., RAM 214, or in a storage medium, e.g., disk unit 220. Data structure 801 may comprise particular frame identifications, e.g., frame numbers, where each frame identification may be associated with a particular sequence number. As stated above, the sequence number indicates when the frame was transmitted by transmitting node 101 with respect to the other frames transmitted to destination node 103 associated with data structure 801. For example, referring to FIG. 8, frame #2, i.e., the frame associated with data structure 701B, has a sequence number of 1. Frame #3, i.e., the frame associated with data structure 701C, has a sequence number of 2. Frame #4, i.e., the frame associated with data structure 701D, has a sequence number of 3. Thus, frame #2 was transmitted to destination node 103, e.g., destination node 103B, followed by frame #3 which was then followed by frame #4.

Referring to FIG. 8, each entry of data structure 801 may further comprise information as to whether the frame as identified by the frame identification was transmitted with a request to transmit an acknowledgment or not. Referring to FIG. 8, frame #2 associated with data structure 701B was transmitted with a request to transmit an acknowledgment as indicated by “EX.” Frame #3 associated with data structure 701C was transmitted with a request not to transmit an acknowledgment as indicated by “IX.” Frame #4 associated with data structure 701D was transmitted with a request to transmit an acknowledgment.

Upon reading the data structure of destination node 103, e.g., destination node 103B, associated with the frame identified in step 312, transmitting node 101 may indicate the received acknowledgment for the appropriate frame in step 315. For example, transmitting node 101 may indicate in the third entry in data structure 801 that frame #4, i.e., the frame associated with data structure 701D, associated with sequence number 3 has been delivered by marking that entry.

In step 316, transmitting node 101 may determine if there are any previous entries in data structure 801 read in step 314 that have not been identified, e.g., marked. That is, transmitting node 101 may determine if there are any previously transmitted frames that have not been identified as having been received by destination node 103 in data structure 801 read in step 314.

If there are any previous entries in data structure 801 read in step 314 that have not been identified, e.g., marked, then transmitting node 101 may determine if the previous unidentified entry is an implicit acknowledgment that needs to be identified in step 317. For example, since destination node 103, e.g., destination node 103B, may transmit an acknowledgment upon receiving a frame with an expected acknowledgment, transmitting node 101 may identify any previous frames with an implicit acknowledgment as having been received by the destination node 103, e.g., destination node 103B. If transmitting node 101 identifies the previous entry as an implicit acknowledgment that needs to be identified, then transmitting node 101 may identify that entry in step 318. For example, referring to FIG. 8, if destination node 103B transmitted an acknowledgment that it received frame #4, i.e., the frame associated with data structure 701D, then transmitting node 101 may identify frame #3, i.e., the frame associated with data structure 701C with an implicit acknowledgment, was received as well. Upon identifying the entry associated with the implicit acknowledgment, transmitting node 101, in step 319, may identify the entry in data structure 701, e.g., data structure 701C, of the frame, e.g., frame #3, associated with the implicit acknowledgment. That is, in step 319, transmitting node 101 may identify the entry in data structure 701 of the frame associated with the implicit acknowledgment that contains the destination node 103 that transmitted the acknowledgment and the associated sequence number. For example, referring to FIG. 7, transmitting node 101 may identify the second entry of data structure 701C, i.e., data structure 701 of frame #3.

Upon identifying the entry in data structure 701, e.g., data structure 701C, of the frame, e.g., frame #3, associated with the implicit acknowledgment, transmitting node 101 may determine if there are any previous entries in data structure 801 read in step 314 that have not been identified, e.g., marked, in step 315.

Referring to step 317, if transmitting node 101 does not identify the previous unidentified entry as an implicit acknowledgment that needs to be identified, then transmitting node 101 detected a lost acknowledgment in step 320. As stated above, transmitting node 101 may indicate that an acknowledgment has been received in data structure 801 of the appropriate destination node 103 in step 315. If transmitting node 101 identifies a frame associated with the received acknowledgment with a sequence number that is greater than expected, then transmitting node 101 detects a lost acknowledgment in step 320. For example, referring to FIG. 8, if transmitting node 101 indicates that transmitting node 101 received an acknowledgment for frame #4 corresponding to a sequence number of 3 prior to receiving an acknowledgment for frame #2 corresponding to a sequence number of 1, then transmitting node 101 detected a lost acknowledgment, i.e., the acknowledgment for frame #2 was lost. It is noted that transmitting node 101 expects to receive an acknowledgment for frames with an explicit acknowledgment and hence the determination of a missing sequence number is based on frames with an explicit acknowledgment.

Upon detecting a lost acknowledgment in step 320, transmitting node 101 may determine, in step 316, if there are any previous entries in data structure 801 read in step 314 that have not been identified, e.g., marked.

Referring to step 316, if there are no previous entries in data structure 801 read in step 314 that have not been identified, then transmitting node 101 may determine if there are any outstanding responses for the frame, e.g., multicast frame, received in step 321. As stated above, each frame may be associated with data structure 701. As an acknowledgment from each destination node 103 for a particular frame is received, transmitting node 101 may indicate in the appropriate entry in the appropriate data structure 701 associated with the delivered frame that the frame was delivered. That is, transmitting node 101 may indicate each destination node 103 that issued the acknowledgment. Transmitting node 101 may then determine if there are any more destination nodes 103 that have not issued an acknowledgment of having received the particular frame in question in step 321. That is, transmitting node 101 may determine if there are any outstanding responses, i.e., any outstanding acknowledgments from destination nodes 103, with respect to the frame identified in step 312.

If there outstanding responses, i.e., any outstanding acknowledgments from destination nodes 103, then transmitting node 101 may wait to receive a further acknowledgment from another destination node 103 in step 308.

If transmitting node 101 has identified all the destination nodes 103 that were transmitted the frame identified in step 312 as having transmitted an acknowledgment, then in step 322, transmitting node 101 may release memory associated with a single copy of the frame identified in step 312.

It is noted that methods 300, 600 may be executed in a different order presented and that the order presented in the discussion of FIGS. 3 and 6 are illustrative. It is further noted that certain steps may be executed almost concurrently.

Although the system, computer program product and method are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for reliably transmitting a frame comprising the steps of:
inserting two or more sequence numbers in said frame, wherein each of said two or more sequence numbers is associated with a destination node; and
transmitting said frame to two or more destination nodes.

2. The method as recited in claim 1 further comprising the step of:
inserting one or more bits in a frame header of said frame to select appropriate ports in a switch fabric to transmit said frame.

3. The method as recited in claim 2 further comprising the step of:
setting a bit in said frame header of said frame to indicate an explicit or an implicit acknowledgment.

4. The method as recited in claim 1 further comprising the step of:
saving a copy of said transmitted frame.

5. The method as recited in claim 1 further comprising the step of:
receiving an acknowledgment from a particular destination node of said two or more destination nodes.

6. The method as recited in claim 5 further comprising the steps of:
identifying said particular destination node;
identifying a frame associated with said acknowledgment;
reading a data structure associated with said particular destination node; and
determining if a sequence number associated with said acknowledgment is greater than an expected sequence number.

7. The method as recited in claim 6, wherein if said sequence number associated with said acknowledgment is greater than said expected sequence number then the method further comprises the step of:
detecting a lost acknowledgment.

8. The method as recited in claim 5 further comprising the steps of:
identifying said particular destination node;
identifying a frame associated with said acknowledgment;
reading a data structure associated with said particular destination node;
indicating in an entry in said data structure associated with said particular destination node that a frame associated with said acknowledgment from said particular destination node has been received; and
identifying a previous entry associated with a frame transmitted with an implicit acknowledgment in said data structure associated with said particular destination node as having been received.

9. The method as recited in claim 5 further comprising the steps of:
identifying said particular destination node;
identifying a frame associated with said acknowledgment;
reading a data structure associated with said frame associated with said acknowledgment; and
indicating in an entry in said data structure associated with said particular destination node that a frame associated with said acknowledgment from said particular destination node has been received.

10. The method as recited in claim 9 further comprising the step of:
determining if there are outstanding responses for said frame associated with said acknowledgment.

11. The method as recited in claim 10, wherein if there are outstanding responses for said frame associated with said acknowledgment then the method further comprises the step of:
waiting to receive an additional acknowledgment.

12. The method as recited in claim 10, wherein if there are no outstanding responses for said frame then the method further comprises the step of:
releasing memory associated with said frame associated with said acknowledgment.

13. The method as recited in claim 1 further comprising the step of:
receiving a request to retransmit said frame from a particular destination node of said two or more destination nodes; and
retransmitting said frame to said particular destination node of said two or more destination nodes.

14. The method as recited in claim 1, wherein said frame is a multicast frame.

15. A computer program product embodied in a machine readable medium for reliably transmitting a frame, comprising:
programming operable for inserting two or more sequence numbers in said frame, wherein each of said two or more sequence numbers is associated with a destination node; and
programming operable for transmitting said frame to two or more destination nodes.

16. The computer program product as recited in claim 15 further comprises:
programming operable for inserting one or more bits in a frame header of said frame to select appropriate ports in a switch fabric to transmit said frame.

17. The computer program product as recited in claim 16 further comprises:
programming operable for setting a bit in said frame header of said frame to indicate an explicit or an implicit acknowledgment.

18. The computer program product as recited in claim 15 further comprises:
programming operable for saving a copy of said transmitted frame.

19. The computer program product as recited in claim 15 further comprises:
programming operable for receiving an acknowledgment from a particular destination node of said two or more destination nodes.

20. The computer program product as recited in claim 19 further comprises:
programming operable for identifying said particular destination node;
programming operable for identifying a frame associated with said acknowledgment;
programming operable for reading a data structure associated with said particular destination node; and
programming operable for determining if a sequence number associated with said acknowledgment is greater than an expected sequence number.

21. The computer program product as recited in claim 20, wherein if said sequence number associated with said acknowledgment is greater than said expected sequence number then the computer program product further comprises:
programming operable for detecting a lost acknowledgment.

22. The computer program product as recited in claim 19 further comprises:
programming operable for identifying a frame associated with said acknowledgment;
programming operable for reading a data structure associated with said particular destination node;
programming operable for indicating in an entry in said data structure associated with said particular destination node that a frame associated with said acknowledgment from said particular destination node has been received; and
programming operable for identifying a previous entry associated with a frame transmitted with an implicit acknowledgment in said data structure associated with said particular destination node as having been received.

23. The computer program product as recited in claim 19 further comprises:
programming operable for identifying said particular destination node;
programming operable for identifying a frame associated with said acknowledgment;
programming operable for reading a data structure associated with said frame associated with said acknowledgment; and
programming operable for indicating in an entry in said data structure associated with said particular destination node that a frame associated with said acknowledgment from said particular destination node has been received.

24. The computer program product as recited in claim 23 further comprises:
programming operable for determining if there are outstanding responses for said frame associated with said acknowledgment.

25. The computer program product as recited in claim 24, wherein if there are outstanding responses for said frame associated with said acknowledgment then the computer program product further comprises:
programming operable for waiting to receive an additional acknowledgment.

26. The computer program product as recited in claim 24, wherein if there are no outstanding responses for said frame then the computer program product further comprises:
programming operable for releasing memory associated with said frame associated with said acknowledgment.

27. The computer program product as recited in claim 15 further comprises:
programming operable for receiving a request to retransmit said frame from a particular destination node of said two or more destination nodes; and
programming operable for retransmitting said frame to said particular destination node of said two or more destination nodes.

28. The computer program product as recited in claim 15, wherein said frame is a multicast frame.

29. A node, comprising:
a processor; and
a memory unit coupled to said processor, wherein said memory unit is operable for storing a computer program operable for reliably transmitting a frame, wherein the computer program is operable for performing the following programming steps:
inserting two or more sequence numbers in said frame, wherein each of said two or more sequence numbers is associated with a destination node; and
transmitting said frame to two or more destination nodes.

30. The node as recited in claim 29, wherein the computer program is further operable for performing the following programming step:
inserting one or more bits in a frame header of said frame to select appropriate ports in a switch fabric to transmit said frame.

31. The node as recited in claim 30, wherein the computer program is further operable for performing the following programming step:
setting a bit in said frame header of said frame to indicate an explicit or an implicit acknowledgment.

32. The node as recited in claim 29, wherein the computer program is further operable for performing the following programming step:
saving a copy of said transmitted frame.

33. The node as recited in claim 29, wherein the computer program is further operable for performing the following programming step:
receiving an acknowledgment from a particular destination node of said two or more destination nodes.

34. The node as recited in claim 33, wherein the computer program is further operable for performing the following programming steps:
identifying said particular destination node;
identifying a frame associated with said acknowledgment;
reading a data structure associated with said particular destination node; and
determining if a sequence number associated with said acknowledgment is greater than an expected sequence number.

35. The node as recited in claim 34, wherein if said sequence number associated with said acknowledgment is greater than said expected sequence number then the computer program is further operable for performing the following programming step:
detecting a lost acknowledgment.

36. The node as recited in claim 33, wherein the computer program is further operable for performing the following programming steps:
identifying said particular destination node;
identifying a frame associated with said acknowledgment;
reading a data structure associated with said particular destination node;
indicating in an entry in said data structure associated with said particular destination node that a frame associated with said acknowledgment from said particular destination node has been received; and
identifying a previous entry associated with a frame transmitted with an implicit acknowledgment in said data structure associated with said particular destination node as having been received.

37. The node as recited in claim 33, wherein the computer program is further operable for performing the following programming steps:
identifying said particular destination node;
identifying a frame associated with said acknowledgment;
reading a data structure associated with said frame associated with said acknowledgment; and
indicating in an entry in said data structure associated with said particular destination node that a frame associated with said acknowledgment from said particular destination node has been received.

38. The node as recited in claim 37, wherein the computer program is further operable for performing the following programming step:
determining if there are outstanding responses for said frame associated with said acknowledgment.

39. The node as recited in claim 38, wherein if there are outstanding responses for said frame associated with said acknowledgment then the computer program is further operable for performing the following programming step:
waiting to receive an additional acknowledgment.

40. The node as recited in claim 38, wherein if there are no outstanding responses for said frame then the computer program is further operable for performing the following programming step:
releasing memory associated with said frame associated with said acknowledgment.

41. The node as recited in claim 29, wherein the computer program is further operable for performing the following programming steps:
receiving a request to retransmit said frame from a particular destination node of said two or more destination nodes; and
retransmitting said frame to said particular destination node of said two or more destination nodes.

42. The node as recited in claim 29, wherein said frame is a multicast frame.

43. A system, comprising:
a transmitting node configured to transmit one or more frames of data;
a switch fabric coupled to said transmitting node configured to direct said transmitted one or more frames of data;
a plurality of destination nodes coupled to said switch fabric, wherein each of said plurality of destination nodes is configured to receive one or more of said one or more frames of data; and
wherein said transmitting node comprises:
a processor; and
a memory unit coupled to said processor, wherein said memory unit is operable for storing a computer program operable for reliably transmitting one or more frames of data, wherein the computer program is operable for performing the following programming steps:
inserting two or more sequence numbers in a frame of data, wherein each of said two or more sequence numbers is associated with one of said plurality of destination nodes; and
transmitting said frame of data to two or more of said plurality of destination nodes.

44. The system as recited in claim 43, wherein the computer program is further operable for performing the following programming step:
inserting one or more bits in a frame header of said frame of data to select appropriate ports in said switch fabric to transmit said frame of data.

45. The system as recited in claim 44, wherein the computer program is further operable for performing the following programming step:
setting a bit in said frame header of said frame of data to indicate an explicit or an implicit acknowledgment.

46. The system as recited in claim 43, wherein the computer program is further operable for performing the following programming step:
saving a copy of said transmitted frame of data.

47. The system as recited in claim 43, wherein the computer program is further operable for performing the following programming step:
receiving an acknowledgment from a particular destination node of said two or more destination nodes.

48. The system as recited in claim 47, wherein the computer program is further operable for performing the following programming steps:
identifying said particular destination node;
identifying a frame of data associated with said acknowledgment;
reading a data structure associated with said particular destination node; and
determining if a sequence number associated with said acknowledgment is greater than an expected sequence number.

49. The system as recited in claim 48, wherein if said sequence number associated with said acknowledgment is greater than said expected sequence number then the computer program is further operable for performing the following programming step:
detecting a lost acknowledgment.

50. The system as recited in claim 47, wherein the computer program is further operable for performing the following programming steps:
identifying said particular destination node;
identifying a frame associated with said acknowledgment;
reading a data structure associated with said particular destination node;
indicating in an entry in said data structure associated with said particular destination node that a frame associated with said acknowledgment from said particular destination node has been received; and
identifying a previous entry associated with a frame transmitted with an implicit acknowledgment in said data structure associated with said particular destination node as having been received.

51. The system as recited in claim 47, wherein the computer program is further operable for performing the following programming steps:
identifying said particular destination node;
identifying a frame of data associated with said acknowledgment;
reading a data structure associated with said frame of data associated with said acknowledgment; and
indicating in an entry in said data structure associated with said particular destination node that a frame associated with said acknowledgment from said particular destination node has been received.

52. The system as recited in claim 51, wherein the computer program is further operable for performing the following programming step:
determining if there are outstanding responses for said frame of data associated with said acknowledgment.

53. The system as recited in claim 52, wherein if there are outstanding responses for said frame associated with said acknowledgment then the computer program is further operable for performing the following programming step:
waiting to receive an additional acknowledgment.

54. The system as recited in claim 52, wherein if there are no outstanding responses for said frame then the computer program is further operable for performing the following programming step:
releasing memory associated with said frame of data associated with said acknowledgment.
